(19) United States
(12) Patent Application Publication
(10) Pub. No.: US 2026/0311430 A1
(43) Pub. Date: Oct. 8, 2026

(54) METHOD FOR CONSTRUCTING UNIFIED GEOINFORMATION MODEL

(71) Applicant: COMPREHENSIVE NATURAL RESOURCES SURVEY CENTER, CHINA GEOLOGICAL SURVEY., BEIJING (CN)

(72) Inventors: ZHENJI GAO, BEIJING (CN); GUOXI SONG, BEIJING (CN); YUE SONG, BEIJING (CN); BIN WANG, BEIJING (CN)

(21) Appl. No.: 19/454,842

(22) Filed: Jan. 21, 2026

(30) Foreign Application Priority Data
Apr. 2, 2025 (CN) 202510407327.9

(51) Int. Cl. G06T 17/10; G06T 9/00

(52) U.S. Cl. CPC G06T 17/10; G06T 9/001

(57) ABSTRACT

a method for constructing a unified geoinformation model may includes: constructing a basic framework for the unified geoinformation model, the basic framework for the unified geoinformation model including a global spherical surface grid partitioning system, a subsurface spatial three-dimensional grid partitioning system, spatial attributes, and time; determining the global spherical surface grid partitioning system; determining the subsurface spatial three-dimensional grid partitioning system; modeling a three-dimensional grid model based on the global spherical surface grid partitioning system and the subsurface spatial three-dimensional grid partitioning system; and assign values to the three-dimensional grid model; performing numerical simulation on the three-dimensional grid model; and constructing a global unified information model application system based on the basic framework for the unified geoinformation model is constructed.

### CROSS REFERENCE TO RELATED APPLICATIONS

The present application claims priority of the Chinese patent application No. 202510407327.9, filed on Apr. 2, 2025, contents of which are incorporated herein by its entirety.

### TECHNICAL FIELD

Embodiments of the present disclosure relate to the technical field of geological model modeling, and more specifically, to a method for constructing a unified geoinformation model.

### BACKGROUND

Spatio-temporal big data may promote discovery in knowledge of earth sciences and may strongly support national major strategic needs such as resource exploration, environmental protection, and land management. Spatio-temporal big data have rich spatio-temporal information, including a plurality of spheres of the Earth, such as an inside of the Earth and a surface of the Earth. Furthermore, the spatio-temporal big data include information of geological evolution processes across millions of years in time. A data volume of the spatio-temporal big data is typically at an ultra-large scale, often at a petabyte (PB) level or above. Furthermore, various professional fields of earth sciences produce data types with various semantics and formats. Therefore, the spatio-temporal big data may be in an extremely large scale, may have extremely rich varieties, and may have an extremely complex structure, such that it may be complex and challenging to organize and manage the spatio-temporal big data.

A holographic geological model for geological spatio-temporal big data shall discover inherent characteristics of geological data to conduct pioneering research, construct a unified geoinformation model, and form a unified expression model for holographic digital earth spatio-temporal big data. In this way, a current trend of global grid partitioning strategies for spatial information integration in geography can be met, geological structures and subsurface distribution of multi-attribute fields can be uniformly described, and integrated organization and analysis of aboveground and subsurface data can be considered.

Therefore, how to construct a unified geoinformation model (UGIM) and achieve a unified expression model for holographic digital earth spatio-temporal data is a significant fundamental issue for building holographic geological digital infrastructure and achieving computation and sharing services for geological big data.

### SUMMARY

The present disclosure provides a method for constructing a unified geoinformation model, so as to form a unified expression model for multi-source heterogeneous spatio-temporal data under a holographic digital earth grid partitioning system.

In order to achieve the above-mentioned objectives, the present disclosure provides the following.

A method for constructing the unified geoinformation model may include following operations.

A basic framework for the unified geoinformation model is constructed. The basic framework for the unified geoinformation model includes a global spherical surface grid partitioning system, a subsurface spatial three-dimensional grid partitioning system, spatial attributes, and time.

The global spherical surface grid partitioning system is determined.

The subsurface spatial three-dimensional grid partitioning system is determined.

A three-dimensional grid model based on the global spherical surface grid partitioning system and the subsurface spatial three-dimensional grid partitioning system is modeled and assigned with values.

Numerical simulation is performed on the three-dimensional grid model.

A global unified information model application system based on the basic framework for the unified geoinformation model is constructed.

Further, constructing the basic framework for the unified geoinformation model includes the following operations.

A coordinate system and a projection method are determined.

A formalized expression of the three-dimensional grid model is determined.

A data model for the unified geoinformation model is defined.

Further, the three-dimensional grid model is represented as a tuple <p, A, f(p)>, so as to describe an attribute value of an attribute A at a position p. The p is three-dimensional or four-dimensional. A three-dimensional grid of the unified geoinformation model is used as a spatial discrete domain of the three-dimensional grid model. Semantic information of an Earth spatial object and spatial distribution information of an attribute parameter are used as field attributes of the three-dimensional grid model. The three-dimensional grid model is formally defined as:

UGIMGrid=<p,M,fₘ(p)>

The UGIMGrid represents the three-dimensional grid model, M={m₀, m₁, m₂, . . . } is a set of all spatial object attributes m that need to be integrated. The fₘ(p) is a mapping function that is used to map a spatial position of the position p at a current moment within a three-dimensional grid space R³ onto a value of the attribute m.

Further, the global spherical surface grid partitioning system is used in the three-dimensional grid model horizontally, and the three-dimensional grid model is divided vertically according to subsurface spatial discretization requirements. In this way, grid cells in a horizontal direction are quadrilateral in shape of a global spherical surface grid form; and grid cells in a vertical direction, towards a center of the Earth, form regular or irregular grids, i.e., the grid cells in the vertical direction are triangular prisms or quadrangular prisms. A basic shape of an interface between two of the grid cells within one prism is quadrilateral. The interface between the two grid cells represents a geological boundary or a fault surface. A set of spatial relationships R for interfaces between grid cells is expressed as:

$$\begin{matrix}R = \{ {r}_{i j} \} \\ {r}_{{i}_{j}} = < {F}_{i} , {F}_{j} >\end{matrix}$$

The rᵢ_{ⱼ} represents a spatial relationship between two different grid cell interfaces Fᵢ and Fⱼ. The Fᵢ and the spatial relationship rᵢ_{ⱼ} are defined as follows.

1. Within one spherical surface partitioning cell, the grid cell interface Fᵢ is a single-valued curved surface. A piecewise function expression for the Fᵢ is Fᵢ=z(x, y). An explicit function zᵢ(x, y) is an interpolation function on a discrete cell, describing an z value of the Fᵢ at a position of (x, y).

2. The spatial relationship rᵢ_{ⱼ} defines a topological relationship of whether two grid cell interfaces intersect with each other and a directional relationship between the two grid cell interfaces along a radial Z-direction of the Earth.

According to the above, the following spatial relationship is obtained:

$${r}_{i j} = \{ \begin{matrix}{F}_{i} intersects with {F}_{j} ⇔ {F}_{i} ⋂ {f}_{j} \neq ∅ \\ {F}_{i} above {F}_{j} ⇔ {z}_{i} ( x , y ) \geq {z}_{j} ( x , y ) or {F}_{i} below {F}_{j} ⇔ {z}_{i} ( x , y ) \leq {z}_{j} ( x , y )\end{matrix}$$

The rᵢ_{ⱼ} is set based on geological conditions, utilizing a geological intersection relationship between the Fᵢ and the Fⱼ and a chronological order of formation of the Fᵢ and the Fⱼ.

Furthermore, determining the global spherical grid partitioning system specifically includes the following operations:

A grid origin is determined.

A multi-level spherical surface grid division scheme is constructed.

Multi-level resolutions, which are compatible with the multi-level spherical surface grid division scheme, are set.

Spherical surface grids are encoded according to the multi-level spherical surface grid division scheme.

Furthermore, determining the subsurface spatial three-dimensional grid partitioning system specifically includes the following operations.

A three-dimensional grid starting point is determined.

A multi-level three-dimensional grid division scheme is constructed.

Multi-level resolutions, which are compatible with the multi-level three-dimensional grid division scheme, are set.

Three-dimensional grids are encoded according to the multi-level three-dimensional grid division scheme.

Furthermore, modeling and assigning values to the three-dimensional grid model based on the global spherical surface grid partitioning system and the subsurface spatial three-dimensional grid partitioning system specifically includes the following operations.

Multi-dimensional geological data are obtained. A three-dimensional geological structure model is constructed based on the multi-dimensional geological data. A three-dimensional geoscience attribute model for a subsurface three-dimensional space or an interior of a geological body is generated under boundary constraints of the three-dimensional geological structure model.

Data of three-dimensional geological structure models and three-dimensional geoscience attribute models that originate from different sources are integrated and are uniformly converted into the data model of the unified geoinformation model.

Data of subsurface spatial artificial structure models that originate from different sources are integrated and uniformly converted them into the data model of the unified geoinformation model.

Spatio-temporal semantic attributes are assigned, based on the data model of the unified geoinformation model, to the three-dimensional grid model, and grid attributes and grid values are managed.

Furthermore, when integrating the data from the three-dimensional geological structure models, the three-dimensional geoscience attribute models, and the subsurface spatial artificial structure models that originate from different sources, the data are classified and identified by performing the following operations.

A large model is pre-trained using a training dataset. A model integration scenario classification dataset is input into the large model. Parameters of the large model are adjusted. The large model having post-adjusted parameters is output.

A clustering loss is calculated, based on the large model and a small model, for feature distribution output by each same data instance in the model integration scenario classification dataset.

The small model matches true labels of data instances using a standard cross-entropy loss function to obtain a standard cross-entropy loss.

An overall loss function is determined based on the clustering loss and the standard cross-entropy loss, and parameters of the small model are updated through backpropagation, until the overall loss function converges, and the small model is output.

The data are classified and identified using the small model.

Furthermore, calculating the clustering loss, based on the large model and a small model, for feature distribution output by each same data instance in the model integration scenario classification dataset, includes the following operations.

For the same data instance in the model integration scenario classification dataset, after being processed by the large model and the small model respectively, a first feature distribution and a second feature distribution are output respectively.

The first feature distribution and the second feature distribution are respectively mapped to different reproducing kernel Hilbert spaces.

Clustering centers for each feature distribution, which is output by the large model and the small model when processing a plurality of data instances with a same label, are calculated to obtain a first clustering center and a second clustering center.

A clustering-center distance between the first clustering center and the second clustering center is calculated. A sum of all clustering-center distances for all first clustering centers and all second clustering centers across all labels is calculated to obtain the clustering loss.

Furthermore, performing the numerical simulation on the three-dimensional grid model includes geological process simulation, time attribute encoding, and extension encoding. Compared to the related art, following technical effects can be achieved.

According to the method for constructing the unified geoinformation model provided in the present disclosure, for the multi-source heterogeneous geological big data, the basic framework of the unified geoinformation model is firstly constructed. The global spherical surface grid partitioning system and the subsurface spatial three-dimensional grid partitioning system are respectively determined. Three-dimensional grid model based on the global spherical surface grid partitioning system and the subsurface spatial three-dimensional grid partitioning system are modeled and are assigned with values, and numerical simulation is performed on the three-dimensional grid model. In this way, theories for organizing and encoding above surface and subsurface spatial information with multi-attribute fields, multi-scales, and multi-level data, are developed. Demands for expressing non-uniform and dynamic geological information and for organizing integrated above surface and subsurface data can be met. In this way, support for constructing a global unified information model application system based on the basic framework of the unified geoinformation model is provided.

### BRIEF DESCRIPTION OF THE DRAWINGS

In order to illustrate technical solutions in embodiments of the present disclosure more clearly, the accompanying drawings for describing the embodiments are briefly described in the following. Obviously, the accompanying drawings in the following description show only preferred embodiments of the present disclosure. Any ordinary skilled person in the art shall obtain other drawings based on the following accompanying drawings without making creative work.

FIG. 1 is a flow chart of a method for constructing a unified geoinformation model according to an embodiment of the present disclosure.

FIG. 2 is a schematic diagram of a global spherical surface grid partitioning system according to an embodiment of the present disclosure.

FIG. 3 is a schematic diagram of a subsurface spatial three-dimensional grid partitioning system according to an embodiment of the present disclosure.

FIG. 4 is a schematic diagram of grid partitioning of the unified geoinformation model according to an embodiment of the present disclosure.

FIG. 5 is a schematic diagram of a global grid unified encoding format according to an embodiment of the present disclosure.

FIG. 6 is a schematic diagram of expressive composition of three-dimensional grids in the unified geoinformation model according to an embodiment of the present disclosure.

### DETAILED DESCRIPTIONS

Principles and features of the present disclosure are described below by referring to the accompanying drawings. The examples are only described to explain the present disclosure and not to limit the scope of the present disclosure.

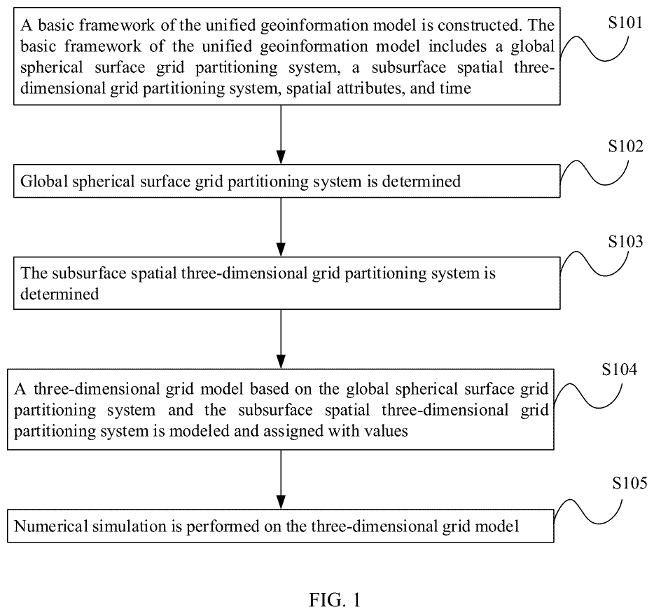

FIG. 1 shows a flow chart of a method for constructing a unified geoinformation model according to an embodiment of the present disclosure. The method includes the following operations.

S101, a basic framework of the unified geoinformation model is constructed. The basic framework of the unified geoinformation model includes a global spherical surface grid partitioning system, a subsurface spatial three-dimensional grid partitioning system, spatial attributes, and time.

S102, a global spherical surface grid partitioning system is determined.

S103, the subsurface spatial three-dimensional grid partitioning system is determined.

S104, a three-dimensional grid model based on the global spherical surface grid partitioning system and the subsurface spatial three-dimensional grid partitioning system is modeled and assigned with values.

S105, numerical simulation is performed on the three-dimensional grid model.

S106, a global unified information model application system based on the basic framework of the unified geoinformation model is constructed.

In the S101, the basic framework of the unified geoinformation model can be expressed as:

UGIM=(G,Z,A,T)

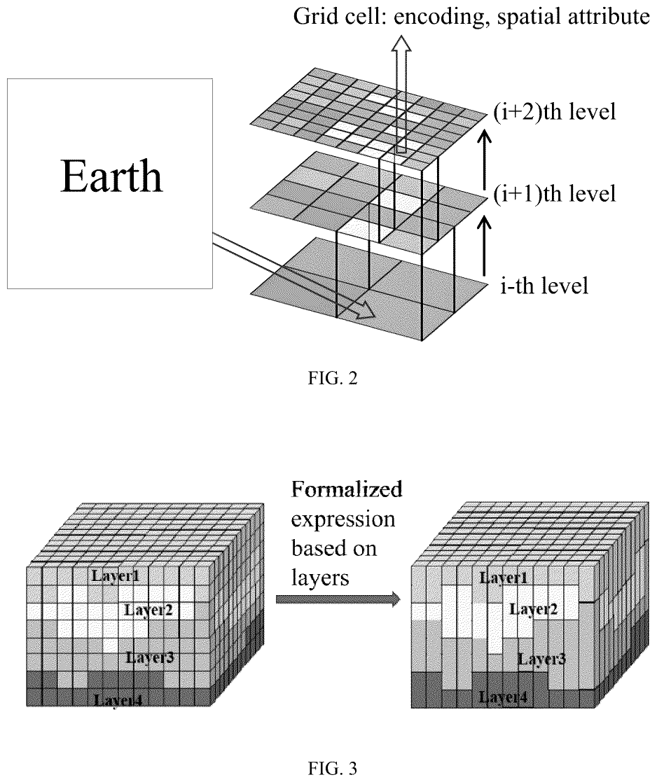

The G represents the global spherical surface grid partitioning system, which meets current requirements for global grid partitioning and spatial data integration and meets current relevant standards in surveying, mapping, and geographic information fields in China, such as the standard based on GeoSOT. A scheme for the global spherical surface grid partitioning system may include a spherical surface partition grids based on a latitude-longitude network, as shown in FIG. 2.

As shown in FIG. 3, the Z represents the subsurface spatial three-dimensional grid partitioning system. The Z is a scheme for partitioning, in a vertical dimension along a radius of the Earth, a subsurface three-dimensional space corresponding to each surface grid cell, and resulting three-dimensional cells thereof may be either regular or irregular in shape. The subsurface three-dimensional space may be a natural geological space or an artificial subsurface structure. Since the Earth is considered as a sphere in global grid partitioning, with a geoid approximately mapped onto the sphere, a datum reference for the Z can be chosen either as the geoid (for elevation) or as a center of the Earth. Spatial discretization of the Z along the radial direction of the Earth can reflect geological features or features of the artificial structure, so as to form data organization for a unified spatio-temporal data model.

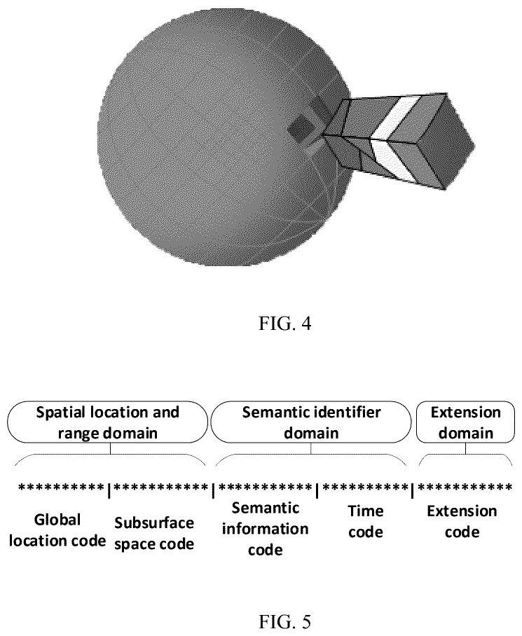

As shown in FIG. 4, the G and the Z cooperatively form the globally unified grid division of the subsurface space, forming a discretized spatial grid model. Each grid cell is filled with characteristic attributes (geological attributes or other attributes). Attribute values of each spatial grid cell may vary over time.

The A represents the spatial attributes (such as the geological attributes or geological semantic information). A=<id, parent_id, P>. Considering fusion of multiple semantic information and consistency between the semantic information and spatial grids, a parent-child association relationship for geological semantic IDs <id, parent_id> is established. The P is a specific attribute value or description. According to semantic association, discretization of the spatial grids may be performed under semantic constraints, ensuring consistency between a part of the geological semantics and spatial representation. For example, stratigraphic ages may be spatially discretized according to hierarchical classification based on erathem, system, series, and formation, such that multi-level associations between semantics and the spatial grids may be achieved.

The T represents the time. The T defines an Earth spatial discretization method and filling of multi-attributes of the Earth at a current moment. Internal attribute values of the grid cells may change over time.

In the present embodiment, the Earth grids based on the basic framework of the unified geoinformation model may be encoded in a unified manner. In a horizontal direction of the Earth surface, spatial information and the semantic attributes of each entity may be encoded in a unified manner based on a location code under the global spherical surface grid partitioning system. In this way, information association, tracking, and sharing may be achieved easily. In a vertical direction of the subsurface space, spatial information for each subsurface spatial cell (such as a geological cell or a subsurface spatial structure cell) is encoded. Based on encoding and decoding, entity information at a specific location in the subsurface space may be relatively and generally understood. A unified encoding in a subsurface spatial domain may be used to: 1) characterize origins and migration constraints of multi-element natural resources; 2) serve as a data encoding format for information sharing, enabling information to be simply and generally understood through decoding, where the simply and generally understood information may be, for instance, a geographical location, a Z-direction distribution range, main semantic information of subsurface spatial cells, and so on.

As shown in FIG. 5, the global grid unified encoding includes a spatial location and range domain, corresponding to the global location code and a subsurface spatial code. The subsurface space code defines a spatial distribution range of attributes within the grid cell and may be approximately limited using a z-value range of an irregular top surface and an irregular bottom surface of a geological cell or limited by a regular grid. A semantic identifier domain is substantially used to encode subsurface spatial semantics (such as geological semantics or subsurface spatial structure semantics) and time. An extension domain encoding is used to provide professional explanatory extensions for the location code.

For the method provided in the present embodiment, the basic framework of the multidimensionally and spatio-temporally unified geoinformation model is constructed, new perspectives and approaches are provided for research in Earth sciences. The basic framework comprehensively integrates multiple spatial dimensions and temporal variables, aiming to enhance characterization, analysis, prediction, early warning, and forecasting of complexity and dynamic changes of the Earth system. Based on the basic framework, a systematic and comprehensive technical process is developed, providing robust support for subsequent applications. The method may generally include the following key operations.

First, the basic framework of the comprehensive and unified geoinformation model is prepared to ensure theoretical consistency and scientific rigor throughout research processes.

Second, the global spherical surface grid partitioning system, which is appropriate for spatial distribution characteristics across the globe, is designed and determined, so as to achieve precise representation of features of the Earth surface.

Next, the subsurface spatial three-dimensional grid partitioning system for complex structures in the subsurface space is constructed to fully reflect multi-layered characteristics of an interior of the Earth.

Concurrently, the three-dimensional grid model is modeled and assigned with numbers, and advanced 3D modeling techniques and three-dimensional grid-based methods are performed to enhance modelling accuracy and reliability.

Subsequently, numerical simulation is performed based on the three-dimensional grid model to explore responses and changes of the Earth system under various scenarios.

Finally, based on the above research outcomes, the unified global information model application system is established to provide support and guidance for natural resource management, environmental dynamic monitoring, and various scientific research.

The above technical approach provides a new direction in Earth information science research provides a solid foundation for advancing related applications.

In an embodiment, constructing the basic framework of the unified geoinformation model includes the following operations:

S201, a coordinate system and a projection method are determined.

In the basic framework of the unified geoinformation model, selection of the coordinate system and the projection method directly determines accuracy, representation, and application effectiveness of geospatial information.

In the present embodiment, the China Geodetic Coordinate System 2000 is applied for the coordinate system of the unified geoinformation model. Application of the above coordinate system may accurately display the spatio-temporal information of the entire Earth, including information on surface coverage layers (such as topography, geomorphology, surface features, and geology) and information of subsurface spatial layers. A user may quickly fine a target location by inputting coordinate values or performing location positioning, and may obtain detailed spatial semantic information and positional relationships.

In the present embodiment, a spherical surface projection is applied as the projection method. The spherical surface projection is a method that projects the Earth surface onto a plane. For the spherical surface projection, continuity and integrity of the Earth's surface may be maintained, and projection distortion may be reduced. The Web Mercator projection is applied in the unified geoinformation model, and the Earth's surface is divided into a plurality of grids. Each of the plurality of grids is projected based on a portion of the spherical surface. By performing the above projection method, full coverage of the Earth's surface may be achieved, and accuracy and clarity of spatio-temporal information may be ensured.

In S202, formalized expression of the three-dimensional grid model is determined.

In the present embodiment, the formalized expression of the three-dimensional grid model is used to uniformly describe spatial objects and continuous field data and to uniformly define association between spatio-temporal locations and attributes. Specifically, the three-dimensional grid model may be represented as a tuple <p, A, f(p)>, configured to describe an attribute value of an attribute A at a position p. The p is three-dimensional or four-dimensional.

The three-dimensional grid model describes various spatial objects and attribute distributions by combining into solid cells. The three-dimensional grid model aggregates into objects or attribute fields in a spatial discrete domain. Three-dimensional grids of the unified geoinformation model are taken as the spatial discrete domain of the three-dimensional grid model, and the semantic information of the Earth spatial objects and spatial distribution information of attribute parameters are taken as the field attributes of the three-dimensional grid model. The three-dimensional grid model is formally defined as:

UGIMGrid=<p,M,fₘ(p)>

The UGIMGrid represents the three-dimensional grid model, M={m₀, m₁, m₂, . . . } is a set of all spatial object attributes m that need to be integrated. The fₘ(p) is a mapping function that is used to map a spatial position of the position p at a current moment within a three-dimensional grid space R³ onto a value of the attribute m.

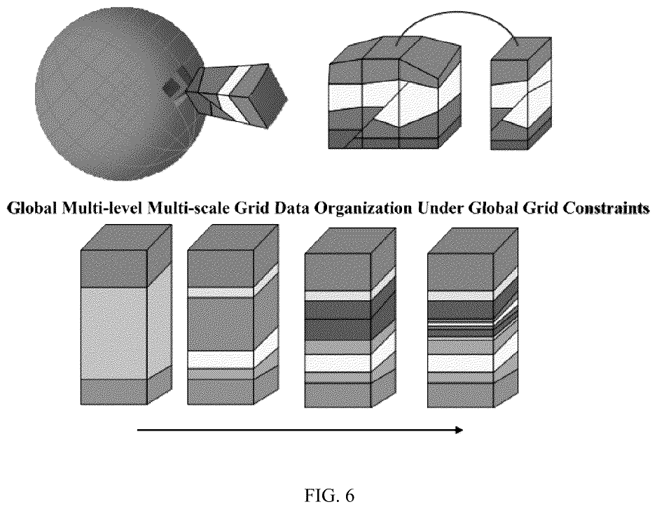

In the present embodiment, a grid partitioning strategy under a global spherical surface grid system is applied in the unified geoinformation model. The global spherical surface grid partitioning system is used in the three-dimensional grid model horizontally, and the three-dimensional grid model is divided vertically according to subsurface spatial (such as geological interfaces or geological attributes) discretization requirements. In this way, grid cells in a horizontal direction are quadrilateral in shape of a global spherical surface grid form; and grid cells in a vertical direction, towards a center of the Earth, form regular or irregular grids, i.e., the grid cells in the vertical direction are triangular prisms or quadrangular prisms. Dividing each grid is performed by considering geological semantics and spatial boundaries, and so on. In this way, various types of grid cells are formed gradually. The global spherical surface grid system meets current standards in surveying and mapping and in geographic information fields. Alternatively, a spherical surface partitioning strategy based on a latitude-longitude network may be performed, and in this case, the three-dimensional grid may be designed as either a regular grid or an irregular grid, as shown in FIG. 6. In this way, a spatially multi-scaled global grid data model is formed, and division or multi-attribute fusion under semantic constraints may be achieved.

In the global spherical surface grid partitioning system, a basic shape of an interface between two of the grid cells within one prism is quadrilateral. The interface between the two grid cells represents a geological boundary or a fault surface. A set of spatial relationships R for interfaces between grid cells is expressed as:

$$\begin{matrix}R = \{ {r}_{ij} \} \\ {r}_{{i}_{j}} = < {F}_{i} , {F}_{j} >\end{matrix}$$

The rᵢ_{ⱼ} represents a spatial relationship between two different grid cell interfaces Fᵢ and Fⱼ. The Fᵢ and the spatial relationship rᵢ_{ⱼ} are defined as follows.

1. Within one spherical surface partitioning cell, the grid cell interface Fᵢ is a single-valued curved surface. A piecewise function expression for the Fᵢ is Fᵢ=z(x, y). An explicit function zᵢ(x, y) is an interpolation function on a discrete cell, describing an z value of the Fᵢ at a position of (x, y).

2. The spatial relationship rᵢ_{ⱼ} defines a topological relationship of whether two grid cell interfaces intersect with each other and a directional relationship between the two grid cell interfaces along a radial Z-direction of the Earth.

According to the above, the following spatial relationship is obtained:

$${r}_{i j} = \{ \begin{matrix}{F}_{i} intersects with {F}_{j} ⇔ {F}_{i} ⋂ {f}_{j} \neq ∅ \\ {F}_{i} above {F}_{j} ⇔ {z}_{i} ( x , y ) \geq {z}_{j} ( x , y ) or {F}_{i} below {F}_{j} ⇔ {z}_{i} ( x , y ) \leq {z}_{j} ( x , y )\end{matrix}$$

The rᵢ_{ⱼ} is set based on geological conditions, utilizing a geological intersection relationship between the Fᵢ and the Fⱼ and a chronological order of formation of the Fᵢ and the Fⱼ, such as angular unconformity, rock intrusion, and primary-secondary relationships between faults. According to the spatial relationships, all geological boundaries or fault surfaces may be linked to each other in a graph to form a spatial relationship binary tree.

In S203, a data model of the unified geoinformation model is defined.

In the present embodiment, the three-dimensional grid of the unified geoinformation model is in a form of a quadrangular prism, essentially expressing three-dimensional grid cell interfaces and spatial relationships thereof, so as to represent substance structures and composition of the subsurface space. Data organization and unified operations on the grids of the unified geoinformation model may be achieved by designing a SurfaceGrid. The SurfaceGrid is a grid model formed by three-dimensional interfaces, such as geological strata and faults, which are irregular and discontinuous within the radial space of the Earth. The SurfaceGrid substantially describes three-dimensional spatial interfaces (such as stratum surfaces or fault surfaces). The three-dimensional spatial grid cells are assembled from the three-dimensional spatial interfaces. The three-dimensional spatial grid cells are shown as polyhedrons in overall.

A quadrilateral cell interface object formed within the quadrangular prism is referred to as a SurfaceCell. The geological interface and the fault surface F are assembled from SurfaceCells, i.e.:

$$F = \{ {SurfaceCell}_{ij} \} = \{ < {z}_{i , j} , {z}_{i + 1 , j} , {z}_{i + 1 , j + 1} , {z}_{i , j + 1} , id , treeIndex > \}$$

The SurfaceCell includes 6 attributes, including z-values of four grid points, a geological attribute ID where the SurfaceCell is located, and a node position Index in the spatial relationship binary tree. The boundary and an internal attribute of each spatial object may be obtained through the SurfaceGrid.

Determining the global spherical surface grid partitioning system is an important foundation for constructing an efficient Earth system model, and technical and theoretical details in various aspects are involved. First, in the above system, determining the grid origin is an essential operation, where distribution of global geographic coordinates needs to be considered to ensure that the selected origin can effectively cover the entire spherical surface, such that a uniformly distributed grid layout can be achieved. Second, designing the multi-level partitioning scheme is crucial, where flexible solutions may be provided according to various research needs, such that applications from global to regional scales can be supported. For example, for meteorological, oceanic, or geological studies, appropriate grid partitioning levels can be selected. In this way, while a computational efficiency can be ensured, a level of detail of the model can be improved. Furthermore, formulation of multi-level resolutions shall also be coordinated with demands of specific applications. Different levels of resolution may assist researchers in better capturing characteristics of specific phenomena, more precise data may be input for numerical simulations. Finally, spherical surface grid encoding is an important technique for achieving efficient computation and data exchange. The spherical surface grid encoding involves storing and transmitting the three-dimensional spherical surface grid information using an appropriate encoding manner, so as to facilitate subsequent data processing and analysis. By performing in-depth research and development in the above aspects, a comprehensive, efficient, and highly adaptable global spherical surface grid partitioning system can be established, providing a solid foundation for related scientific research and practical applications.

Accordingly, in another embodiment, determining the global spherical surface grid partitioning system specifically includes the following operations.

In S301, the grid origin is determined.

When constructing the unified geoinformation model, reasonably determining the grid origin is a crucial operation. During the S301, geometric characteristics of the Earth as an approximate sphere must be considered, and specific distribution of global geographic coordinates needs to be deeply analyzed.

In order to determine the grid origin, distribution characteristics of global geographic coordinates needs to be comprehensively considered, ensuring that the selected origin can comprehensively and effectively cover the entire Earth surface, such that the uniformly distributed grid layout can be achieved.

An ideal selection of the grid origin shall meet the following requirements.

Full Coverage: The selected origin shall be located at a position that ensures, while certain grid partitioning rules are applied, the entire Earth surface can be covered without omission. That is, a location, which might cause difficulties in incorporating certain regions, such as polar regions or other geographical anomalies, into the grid system, shall not be selected.

Uniform Distribution: In order to ensure that generated grids can be evenly distributed over the Earth surface, reducing density variations caused by variation in geographical locations, the selection of the origin needs to be made by considering a natural form of the Earth (such as topography, geomorphology) and distribution characteristics of human activities. Ideally, all grid cells shall have an identical area as much as possible. In this way, an efficiency and accuracy of data processing may be improved, and subsequent spatial analysis and modeling may be facilitated.

Computational Simplicity: From the perspective of mathematics and computation, it may be essential to select an origin that allows coordinate transformation and grid generation algorithms to be simplified. An ideal origin may facilitate optimization of a computation process, reducing error accumulation, and improving overall performance of the system.

Compatibility and Standardization: Considering that different countries and regions may use different geographic coordinate systems, an internationally recognized reference point may be selected as the grid origin. In this way, interoperability and data sharing capabilities of the system may be improved. Therefore, international standards, such as World Geodetic System 1984 (WGS84), may be followed, so as to ensure compatibility of the instant system with other geographic information systems or datasets.

Determining the grid origin is a process in which various factors need to be considered. Determining the grid origin may directly affects quality and application effectiveness of the grid layout at a subsequent stage. By performing careful design and scientific demonstration, selecting the origin appropriately may provide a solid foundation for creating an efficient, accurate, and highly compatible unified geoinformation model.

In the global spherical surface grid partitioning system, determining the grid origin substantially involves a longitude direction and a latitude direction and may be customized by the user. For example, two schemes for determining the grid origin can be considered. For a first scheme, a point of 0 degrees East in the longitude direction and 0 degrees in the latitude direction may be selected. For a second scheme, a point of 0 degrees East in the longitude direction and 90 degrees South in the latitude direction may be selected.

In S302, a multi-level spherical surface grid partitioning scheme may be constructed.

In the present embodiment, constructing the multi-level spherical surface grid partitioning scheme may be practical for various applications from global scales to regional scales, and a partitioning range may fully cover the entire Earth. For example, for above surface or geological research, an appropriate grid partitioning level can be selected to enhance the level of detail of the model, while ensuring the computational efficiency.

Exemplarily, grid partitioning levels may include 27 levels in total, from a level 0 to a level 26.

The longitude of the Earth is in a range from −180 degrees to 180 degrees, and the latitude of the Earth is in a range from −90 degrees to 90 degrees.

For level 0 grids:

The longitude starts from 0 degrees to 180 degrees (i.e., starting from the prime meridian towards the east), every +8 degrees are partitioned into 1 grid. The longitude starts from 0 degrees to −180 degrees (i.e., starting from the prime meridian to the west), every −8 degrees are partitioned into 1 grid. The latitude starts from 0 degrees to 90 degrees (i.e., starting from the equator to the north), every +4 degrees are partitioned into 1 grid. The latitude starts from 0 degrees to −90 degrees (i.e., starting from the equator to the south), every −4 degrees are partitioned into 1 grid.

For level 1 to level 3 grids, level 1 grids are obtained by dividing both a size of the longitude grid and a size of the latitude grid of the level 0 by 2. From the level 1 to the level 3, grids of a subsequent level are obtained by dividing sizes of grids of a previous level by 2 in a geometric progression. By a level 5, a size of each grid is 1 degree in the longitude direction and 1 degree in the latitude direction.

For level 4 grids, starting from the prime meridian, the longitude is divided into grids by every +32 minutes to the east and every −32 minutes to the west; and starting from the equator, the latitude is divided into grids by every +16 minutes to the north and every −16 minutes to the south.

For level 5 to level 9 grids: The level 5 grids are generated by dividing a size of the grid of the level 4 in the longitude direction by 2 and dividing a size of the grid of the level 4 in the latitude direction by 2. From the level 5 to the 9, grids of a subsequent level are obtained by dividing sizes of grids of a previous level by 2 in a geometric progression. By the level 9, each grid has a size of 1 minute in the longitude direction and 1 minute in the latitude direction.

For level 10 grids, starting from the prime meridian, the longitude is divided into grids by every +32 seconds to the east and every −32 seconds to the west; and starting from the equator, the latitude is divided into grids by every +16 seconds to the north and every −16 seconds to the south.

For level 11 to level 15 grids: The level 11 grids are generated by dividing a size of the grid of the level 10 in the longitude direction by 2 and dividing a size of the grid of the level 10 in the latitude direction by 2. From the level 11 to the 15, grids of a subsequent level are obtained by dividing sizes of grids of a previous level by 2 in a geometric progression. By the level 15, each grid has a size of 1 second in the longitude direction and 1 second in the latitude direction.

For level 16 to level 26 grids: The level 16 grids are generated by dividing a size of the grid of the level 15 in the longitude direction by 2 and dividing a size of the grid of the level 15 in the latitude direction by 2. From the level 16 to the 26, grids of a subsequent level are obtained by dividing sizes of grids of a previous level by 2 in a geometric progression. By the level 26, each grid has a size of 1/2048 second in the longitude direction and 1/2048 second in the latitude direction.

In S303, multi-level resolutions, which are compatible with the multi-level spherical surface grid partitioning scheme, are set.

In the present embodiment, specification of the multi-level resolutions is compatible with the multi-level spherical surface grid partitioning scheme. Various levels of resolutions may assist researchers in better storing, managing, and representing three-dimensional spatio-temporal features. In this way, more precise data may be provided to be input for numerical simulation. According to the multi-level partitioning scheme, resolutions for grids of 27 levels are shown in Table 1 below.

TABLE 1

| | Grid | Units of longitude | Approximate length | Unit for |
|---|---|---|---|---|
| level | size | and latitude | of grid | length |
| 0 | 8 | degree | 890.5 | km |
| 1 | 4 | degree | 445.3 | km |
| 2 | 2 | degree | 222.6 | km |
| 3 | 1 | degree | 111.3 | km |
| 4 | 32 | minute | 55.7 | km |
| 5 | 16 | minute | 27.8 | km |
| 6 | 8 | minute | 13.9 | km |
| 7 | 4 | minute | 7.0 | km |
| 8 | 2 | minute | 3.5 | km |
| 9 | 1 | minute | 1.7 | km |
| 10 | 32 | second | 869.6 | m |
| 11 | 16 | second | 434.8 | m |
| 12 | 8 | second | 217.4 | m |
| 13 | 4 | second | 108.7 | m |
| 14 | 2 | second | 54.4 | m |
| 15 | 1 | second | 27.2 | m |
| 16 | ½ | second | 13.6 | m |
| 17 | ¼ | second | 6.8 | m |
| 18 | ⅛ | second | 3.4 | m |
| 19 | 1/16 | second | 1.7 | m |
| 20 | 1/32 | second | 0.8 | m |
| 21 | 1/64 | second | 42.5 | cm |
| 22 | 1/128 | second | 21.2 | cm |
| 23 | 1/256 | second | 10.6 | cm |
| 24 | 1/512 | second | 5.3 | cm |
| 25 | 1/1024 | second | 2.7 | cm |
| 26 | 1/2048 | second | 1.3 | cm |

In S304, spherical surface grids are encoded according to the multi-level spherical surface grid partitioning scheme.

In the present operation, encoding of the spherical surface grid is formed by 27 bits. A value of each bit is a quaternary numeral: 0, 1, 2, and 3. An encoding order follows a Z-order curve.

During determining the subsurface spatial three-dimensional grid partitioning system, a plurality of professional factors need to be comprehensively considered to ensure scientificity and practicality of partitioning. First, a starting point of three-dimensional grids is foundation of the partitioning system and must be accurately selected based on specific characteristics of the subsurface space and application requirements. For example, natural factors such as topography, geomorphology, and geology, as well as artificial factors such as above surface and subsurface structures, must be considered, so as to establish a reasonable coordinate system. In this way, the accuracy and consistency of subsequent partitioning can be ensured. Second, design of the multi-level partitioning scheme shall be made by being guided based on functional requirements and data precision, and grid partitioning at various levels may be autonomously adjusted to adapt to various applications, such as urban planning, subsurface resource development, and environmental monitoring. Simultaneously, reasonably setting the multi-level resolutions within the multi-level partitioning scheme is crucial. Reasonably setting the multi-level resolutions requires precise control at various partitioning hierarchies to adapt to subsurface space analyses of various scales and complexities without sacrificing data usability. Finally, systematic design of encoding of the three-dimensional grids enhances manageability and interactivity of data. By applying unified encoding rules, three-dimensional grid data may be efficiently stored, retrieved, and shared. In this way, deep integration of various related research and practical applications may be promoted. Therefore, systematic research and integration in the above aspects may provide a solid foundation for scientific management of the subsurface space.

In another embodiment, determining the subsurface spatial three-dimensional grid partitioning system specifically includes the following operations.

In S401, a starting point for the three-dimensional grids is determined.

The starting point of the three-dimensional grids is controlled by surface topography of the Earth surface and is determined by the global spherical surface grid partitioning system. Partitioning along the radial direction of the Earth starts based on grid resolution defined by the 27-level spherical surface partitioning scheme. At each level, a horizontal grid layout and resolution are kept consistent with those of the corresponding global spherical surface grid at the same level. Level 27 DEM data are applied for topographic data. Accuracy of the level 27 DEM data is consistent with the resolution of the level 27 of the global spherical surface grid.

In S402, a multi-level three-dimensional grid partitioning scheme is constructed.

Designing the multi-level three-dimensional grid partitioning scheme is performed by being guided based on functional requirements and data precision. Grid partitioning at various levels may be autonomously adjusted to adapt to various applications, such as geological resource management, geological environment protection, geological hazard prevention, and subsurface space utilization. Exemplarily, multi-level partitioning of three-dimensional grids may be made by considering grid partitioning of the interior of the Earth, which is substantially affected by the radius of the Earth. The radius of a semi-major axis of the Earth is 6,378,137 meters. The number of levels for the three-dimensional grids is the same as the number of levels for the global spherical surface gris, where 27 levels, from the level 0 to the level 26, are included.

In S403, the multi-level resolutions, which are compatible with the multi-level three-dimensional grid partitioning scheme, are set.

By reasonably setting the multi-level resolutions, the system may be adapted to various subsurface space applications of various scales and complexities without sacrificing data usability. Exemplarily, in the present embodiment, the multi-level resolutions set for the subsurface spatial three-dimensional grid partitioning system is shown in Table 2.

TABLE 2

| | | Unit for | | | Length | |
|---|---|---|---|---|---|---|
| | | longitude | Approximate | | of | |
| | Size of | and | length | Unit for | depth | Unit for |
| level | grid | latitude | for grid | length | grid | length |
| 0 | 8 | degree | 890.50 | km | 4096 | m |
| 1 | 4 | degree | 445.25 | km | 2048 | m |
| 2 | 2 | degree | 222.63 | km | 409.6 | m |
| 3 | 1 | degree | 111.31 | km | 204.8 | m |
| 4 | 32 | minute | 55.66 | km | 102.4 | m |
| 5 | 16 | minute | 27.83 | km | 51.2 | m |
| 6 | 8 | minute | 13.91 | km | 25.6 | m |
| 7 | 4 | minute | 6.96 | km | 12.8 | m |
| 8 | 2 | minute | 3.48 | km | 6.4 | m |
| 9 | 1 | minute | 1.74 | km | 3.2 | m |
| 10 | 32 | second | 869.6 | m | 3.2 | m |
| 11 | 16 | second | 434.8 | m | 1.6 | m |
| 12 | 8 | second | 217.4 | m | 1.6 | m |
| 13 | 4 | second | 108.7 | m | 80 | cm |
| 14 | 2 | second | 54.4 | m | 80 | cm |
| 15 | 1 | second | 27.2 | m | 40 | cm |
| 16 | ½ | second | 13.6 | m | 40 | cm |
| 17 | ¼ | second | 6.8 | m | 20 | cm |
| 18 | ⅛ | second | 3.4 | m | 20 | cm |
| 19 | 1/16 | second | 1.7 | m | 10 | cm |
| 20 | 1/32 | second | 0.8 | m | 10 | cm |
| 21 | 1/64 | second | 42.5 | cm | 5 | cm |
| 22 | 1/128 | second | 21.2 | cm | 5 | cm |
| 23 | 1/256 | second | 10.6 | cm | 2.5 | cm |
| 24 | 1/512 | second | 5.3 | cm | 2.5 | cm |
| 25 | 1/1024 | second | 2.7 | cm | 1.3 | cm |
| 26 | 1/2048 | second | 1.3 | cm | 1.3 | cm |

In S404, the three-dimensional grids are encoded according to the multi-level three-dimensional grid partitioning scheme.

The encoding of the subsurface spatial three-dimensional grids is formed of 27 bits and is performed based on the multi-level three-dimensional grid partitioning scheme. A value of each bit is a binary digit of 0 or 1.

Under the basic framework of the unified geoinformation model, after partitioning the Earth into three-dimensional grids, spatio-temporal semantic attributes need to be assigned to the three-dimensional grids for professional applications. The spatio-temporal semantic attributes may be, such as, geological ages, stratum, structures, lithology, geochemical properties, geophysical properties, hydrogeological parameters, engineering geological parameters, ore grades, and so on. During modeling and assigning values to the three-dimensional grid model, three-dimensional geological modeling is a primary operation and aims to construct, by collecting and analyzing geological data, an efficient model reflecting subsurface geological characteristics. The efficient model may comprehensively consider various geological elements such as strata, structures, and ore bodies and may use advanced modeling software and algorithms to achieve three-dimensional visualization of spatial data. In this way, researchers and engineers may understand a geological environment more intuitively. Subsequently, geological model integration involves effectively combining a plurality of independent geological models to ensure data consistency and integrity. The above process emphasizes inter-disciplinary collaboration and data sharing to maximize applicability and reliability of the model. Furthermore, integration of other models is equally important, and the other models include spatial models of underground structures and buildings that are associated with the geological model. In this way, multi-dimensional analysis and decision-making can be supported. Finally, assigning values to the attributes and management of the attributes are crucial and aim to assign specific physical, chemical, and biological attributes to each cell in the three-dimensional grid model. In this process, realism of the model may be improved, and a solid foundation is provided for subsequent simulation and prediction. The technical approach for assigning the values to the attributes involves developing multi-source and multi-scale voxelization techniques, which convert a three-dimensional vector model into a three-dimensional raster model, while the basic framework of the unified geoinformation model is followed. In the above process, accurate organization and efficient management of attribute data ensure scientific validity and practicality of the model, such that the model may be applied in various fields, such as resource assessment, environmental protection, and engineering design.

In another embodiment, modeling and assigning values for the three-dimensional grid model based on the global spherical surface grid partitioning system and the subsurface spatial three-dimensional grid partitioning system specifically includes the following operations:

In S501, multi-dimensional geological data are obtained. A three-dimensional geological structure model is constructed based on the multi-dimensional geological data. A three-dimensional geoscience attribute model for the subsurface three-dimensional space or the interior of the geological body is generated under boundary constraints of the three-dimensional geological structure model.

For example, modeling the three-dimensional geological structure model may be achieved by performing a knowledge-driven explicit modeling method or a data-driven implicit modeling method. The three-dimensional geoscience attribute model is generated by transforming the multi-dimensional geological data into a spatial potential field, such that a highly precise geoscience attribute model of a three-dimensional space is generated.

In S502, data of three-dimensional geological structure models and three-dimensional geoscientific attribute models originated from various sources are integrated and are uniformly converted into a data model of the unified geoinformation model.

The S502 substantially aims on solving problems caused during data exchange among the three-dimensional geological models, so as to enable reading, parsing, extraction, conversion, validation, and generation of models originated from various sources, and to uniformly convert the data therefrom into the data model of the unified geoinformation model. Formats of the data that are supported in the S502 include OBJ, GOCAD, Petrel, EVS, and Geo3DML. Geometric types for datasets that are supported in the S502 include boreholes, sections, surfaces, vector volumes, and attribute models.

In S503, data of subsurface artificial structure models originated from various sources are integrated and uniformly converted it into the data model of the unified geoinformation model.

For example, the subsurface spatial artificial structure models substantially include a subsurface infrastructure module, a subsurface pipeline module, a subway module, and other BIM models. In the S503, reading, parsing, extraction, conversion, validation, and generation of the subsurface spatial artificial structure models may be achieved, and the subsurface spatial artificial structure models are uniformly converted into the data model of the unified geoinformation model. Formats of the data that are supported in the S503 include IFC.

In S504, the spatio-temporal semantic attributes are assigned, based on the data model of the unified geoinformation model, to the three-dimensional grid model, attributes and attribute values of the three-dimensional grids are managed. The S504 substantially includes the following operations.

### 1) Assigning the Spatio-Temporal Semantic Attributes to the Three-Dimensional Grid Model

Temporal dimension: A time axis is added to the three-dimensional grid model and is used to track changes in specific geological features over time, such as growth or an erosion process of sedimentary layers.

Spatial semantics: Information describing a position of each grid, a size of each grid, and a relationship of each grid with other grids is added to each grid (or referred to as a “voxel”) in the three-dimensional grid model. In this way, the geological object can be more precisely located, and interactions between geological objects can be understood better.

### 2) Managing the Attributes of the Grids and Managing the Values of the Attributes

Defining the attributes: First, it is determined which attributes are important for a research objective. The attributes may include physical properties, such as a rock type, permeability, and porosity; and environmental conditions, such as chemical composition, temperatures, and pressures.

Method for assigning values: Specific values of the attributes are assigned to grid cells based on actual measurement data or inferences from existing knowledge. In the above process, advanced techniques, such as statistical analysis and the application of machine learning algorithms, may be involved.

Dynamic updating: As new data are obtained, the attribute values in the model need to be adjusted accordingly to reflect latest understanding. An effective dynamic updating mechanism is established to manage and maintain any change.

### 3) Spatio-Temporal Semantic Codes

The semantic identification domain is encoded, and subsurface spatial semantics (such as geological semantics or subsurface spatial structure semantics) is mainly encoded.

In an embodiment, when integrating data of the three-dimensional geological structure models, the three-dimensional geoscientific attribute models, or the subsurface spatial artificial structure models originated from various sources, the data are classified and identified by performing the following operations.

In S601, a large model is pre-trained based on a training dataset, a model integration scenario classification dataset is input into the large model to adjust parameters of the large model, and the large model having adjusted parameters is output.

In S602, a clustering loss is calculated, by the large model and the small model, based on feature distributions output from same data instances in the model integration scenario classification dataset.

The large model performs better than the small model but has a greater size and complexity than the small model. Performance of the small model is worse than that of the large model, however, the small model is more compact in size and can be deployed on various platforms more easily.

In S603, the small model matches true labels of data instances using a standard cross-entropy loss function to obtain a standard cross-entropy loss.

In S604, an overall loss function is determined based on the clustering loss and the standard cross-entropy loss, and parameters of the small model are updated through backpropagation, until the overall loss function converges, and the small model is output.

In S605, the data are classified and identified using the small model.

In the present embodiment, by establishing the overall loss function based on the clustering loss and the standard cross-entropy loss, the excellent feature extraction capability of the large model is transferred to the small model. In this way, the small model may efficiently and accurately identify and classify data from various sources in model integration scenarios, such that an efficiency of model integration is improved.

Specifically, calculating, by the large model and the small model, the clustering loss based on feature distributions output from same data instances in the model integration scenario classification dataset includes the following operations.

In S701, for the same data instance in the model integration scenario classification dataset, after being processed by the large model and the small model respectively, a first feature distribution and a second feature distribution are output.

In S702, the first feature distribution and the second feature distribution are respectively mapped to different reproducing kernel Hilbert spaces; and a cluster center for the feature distribution output by the large model and a cluster center for the feature distribution output by the small model are calculated when a plurality of data instances with the same label are being processed. In this way, a first cluster center and a second cluster center are obtained.

In S703, a distance between the first cluster center and the second cluster center is calculated; and a sum of distances between first cluster centers and respective second cluster centers across all labels is calculated. In this way, the clustering loss is obtained.

After assigning values to the three-dimensional grid model, data simulation may be performed on multi-scale models using finite element techniques and artificial intelligence technologies. In this way, dynamic evolution of complex geological processes can be reflected.

In another embodiment, numerical simulation is performed on the three-dimensional grid model. The numerical simulation includes geological process simulation, time attribute encoding, and extension encoding.

First, for the geological process simulation, the three-dimensional grid model can be used for simulating a mineralization process. By precisely modeling formation and evolution of ore bodies and interactions between the ore bodies and surrounding geological environment, researchers are assisted in deeply understanding distribution patterns and formation mechanisms of mineral resources.

Furthermore, geothermal simulation is another key application area. The three-dimensional grid model can simulate heat conduction in a geothermal system, fluid flowing in the geothermal system, and interactions with geological structures, such that scientific basis is provided for development and utilization of geothermal resources.

Furthermore, underground water simulation is also an important application of the three-dimensional grid model. By accurately simulating flowing of the underground water, contaminant migration, and hydrogeological characteristics, strong support is provided for water resource management and environmental protection.

In the above simulation processes, introduction of time attribute encoding is crucial. The time attribute encoding integrates temporal factors into the model, enabling simulation results to be more timely and more accurate. The time attribute encoding further assists researchers in analyzing a variation pattern of geological processes across various time scales. In this way, a more comprehensive decision-making basis is provided for geological research and resource development. In the present embodiment, the time attribute encoding is integrated into the global grid unified encoding.

The extension encoding is used for providing professional expansion and explanation of position encoding.

As globalization and informatization increasingly develop, constructing a global unified information model application system, which is capable of achieving cross-regional and cross-industry data sharing and achieving collaborative work, is of great significance for promoting effective integration and utilization of information resources. By designing and implementing the system, a series of subsystems may work cooperatively to break down information silos, improve a decision-making efficiency, and enhance collaboration capabilities among organizations. Specifically, the global unified information model application system substantially includes the following essential components.

### 1. Model Storage System

The model storage system serves as foundation of the global unified information model application system. The model storage system is configured to efficiently and securely store and manage various information models. The model storage system has powerful data storage capabilities to meet requirements of storing massive data and is provided with a flexible data access interface to support import and export of various data formats, ensuring data consistency and integrity. The model storage system manages large-scale, multi-scale, multi-precision, multi-parameter, and vector-raster integrated high-precision three-dimensional geological attribute models. The model storage system focuses on solving technical issues in storing distributed large-scale grid data, technical issues in distributed grid data computing frameworks, technical issues in data resource access interfaces, technical issues in computing service access interfaces, technical issues in lightweight data processing, and other key technical issues.

The model storage system provides grid database management and grid dataset management. The grid database management provides functions such as creating, connecting, modifying, and deleting grid databases. The grid dataset management provides functions such as creating new grid model dataset groups, reading model dataset groups, deleting grid model dataset groups, renaming grid model dataset groups, creating new grid model datasets, reading grid model datasets, writing to grid model datasets, deleting grid model datasets, updating grid model datasets, renaming grid model datasets, creating new fields in grid model datasets, deleting fields in grid model datasets, and editing fields in grid model datasets.

### 2. Model Publishing System

The model publishing system serves as a bridge connecting model developers with end-users. The model publishing system enables, via standardized three-dimensional service interfaces, unified service management, thematic scene customization, service publishing, rapid deployment, and widespread dissemination of the unified geoinformation model. The model publishing system enables service registration, service application, service approval, service publishing, and service management. The model publishing system provides satisfied user experience and a simplified model publishing process. A barrier for using the model publishing system is lowered, and non-professionals may get started using the model publishing system easily.

The three-dimensional service interface of the unified geoinformation model (UGIM3D API) follows RESTful design specifications and can be invoked by a three-dimensional client side.

The three-dimensional service interface includes the following contents. UGIM3DData: The three-dimensional service interface includes a data information retrieval service, which is configured to obtain metadata information of service data, describing basic data information, a version number, a data name, a data type, a spatial reference system, and so on.

UGIM3DSharedResources: The three-dimensional service interface includes a public resource retrieval service, which is configured to obtain public resource data under the UGIM3D data, including materials, textures, and feature information.

UGIM3DRootNodeInfo: The three-dimensional service interface includes a root node information retrieval service, which is configured to obtain metadata information of the root node under UGIM3D data, describing a node name, a node LOD level, a node bounding sphere range, and so on.

UGIM3DNodeInfo: The three-dimensional service interface includes a node description information retrieval service, which is configured to obtain metadata information of child nodes under the root node in the data, describing a node name, a node LOD level, a node bounding sphere range, and so on.

UGIM3DNodeData: The three-dimensional service interface includes a node data information retrieval service, which is configured to obtain data information associated with nodes, including geometry, attributes, materials, and texture data.

UGIM3DGeometryData: The three-dimensional service interface includes a geometry information retrieval service, which is configured to obtain feature geometry information associated with nodes.

UGIM3DTextureData: The three-dimensional service interface includes a texture information retrieval service, which is configured to obtain texture information of specified textures on nodes.

UGIM3DAttributeData: The three-dimensional service interface includes an attribute information retrieval service, which is configured to obtain feature attribute information associated with nodes.

### 3. Model Analysis System

The model analysis system focuses on in-depth mining and intelligent analysis of the multi-dimensional spatio-temporal unified geoinformation model. Machine learning and deep learning data analysis techniques are applied in the model analysis system, so as to achieve virtual geological borehole analysis, virtual geological section analysis, virtual geological excavation analysis, virtual geological block cutting analysis, point-based holographic analysis, linear holographic analysis, surficial holographic analysis, scenario simulation, prediction, early warning, and other function. In this way, the user is provided with data insights and decision support. The model analysis system can automatically identify key information in models, discover potential data correlations, and assist the user in formulating more scientific and rational strategic plans. The model analysis system provides customized report generation capabilities, so as to present complex analysis results to the user in an intuitive and understandable form, such that decision may be made more transparently and accurately.

### 4. Professional Application System

The professional application system targets specific industries or fields, providing highly customized solutions based on the unified geoinformation model at national, regional, provincial, municipal, and site-specific scales. The above applications cover digital metallogenic belts, digital basins, digital watersheds, digital coastal zones, subsurface spaces, digital oceans, and other key areas. By operating closely cooperatively with the model storage system, the model publishing system, and the model analysis system, the professional application system serves as an outlet for multi-domain demonstration applications. The professional application system fully utilizes existing information resources, achieves deep integration and integrated services with real-scene three-dimensional China and the national land space basic information platform, and meets demands of various user groups. The professional application system typically provides diverse interactive interfaces and service modes, offering important support for natural resources three-dimensional survey, supervision, deep mineral resource assessment, and subsurface space development and utilization.

The above specification describes merely preferred embodiments of the present disclosure and is not intended to limit the present disclosure. Any modifications, equivalent replacements, and improvements made within the spirit and principles of the present disclosure shall be included within the scope of the present disclosure.

What is claimed is:

1. A method for constructing a unified geoinformation model, the method comprising:
constructing a basic framework for the unified geoinformation model, wherein, the basic framework for the unified geoinformation model comprises a global spherical surface grid partitioning system, a subsurface spatial three-dimensional grid partitioning system, spatial attributes, and time;
determining the global spherical surface grid partitioning system;
determining the subsurface spatial three-dimensional grid partitioning system;
modeling a three-dimensional grid model based on the global spherical surface grid partitioning system and the subsurface spatial three-dimensional grid partitioning system; and
assigning values for the three-dimensional grid model;
performing numerical simulation on the three-dimensional grid model;
constructing a global unified information model application system based on the basic framework for the unified geoinformation model;
wherein, constructing the basic framework for the unified geoinformation model comprises:
determining a coordinate system and a projection method;
determining a formalized expression of the three-dimensional grid model;
defining a data model for the unified geoinformation model;
wherein, the three-dimensional grid model is represented as a tuple <p, A, f(p)>, so as to describe an attribute value of an attribute A at a position p; the p is three-dimensional or four-dimensional; three-dimensional grids of the unified geoinformation model are used as a spatial discrete domain of the three-dimensional grid model; semantic information of an Earth spatial object and spatial distribution information of an attribute parameter are used as field attributes of the three-dimensional grid model; the three-dimensional grid model is formally defined as:
$$UGIMGrid = < p , M , {f}_{m} ( p ) > ;$$
wherein, the UGIMGrid represents the three-dimensional grid model, M={m₀, m₁, m₂, . . . } is a set of all spatial object attributes m that need to be integrated; the fₘ(p) is a mapping function that is used to map a spatial position of the position p at a current moment within a three-dimensional grid space R³ onto a value of the attribute m;
the global spherical surface grid partitioning system is used in the three-dimensional grid model horizontally; the three-dimensional grid model is divided vertically according to subsurface spatial discretization requirements; grid cells in a horizontal direction are quadrilateral in shape of a global spherical surface grid form; and grid cells in a vertical direction, towards a center of the Earth, are regular or irregular grid cells; the regular or irregular grid cells comprise triangular prisms or quadrangular prisms; a shape of an interface between two of the grid cells within one prism is quadrilateral; the interface between the two grid cells represents a geological boundary or a fault surface; a set of spatial relationships R for interfaces between grid cells is expressed as:
$$\begin{matrix}R = \{ {r}_{ij} \} \\ {r}_{{i}_{j}} = < {F}_{i} , {F}_{j} \text{>;}\end{matrix}$$
the rᵢ_{ⱼ} represents a spatial relationship between two grid cell interfaces Fᵢ and Fⱼ; the Fᵢ and the spatial relationship rᵢ_{ⱼ} are defined as follows:
1. within one spherical surface partitioning cell, the grid cell interface Fᵢ is a single-valued curved surface; a piecewise function expression for the Fᵢ is Fᵢ=z(x, y); an explicit function zᵢ(x, y) is an interpolation function on discrete cells and is configured to describe an z value of the Fᵢ at a position of (x, y);
2. the spatial relationship rᵢ_{ⱼ} defines a topological relationship of whether two grid cell interfaces intersect with each other and a directional relationship between the two grid cell interfaces along a radial Z-direction of the Earth;
a following spatial relationship is obtained according to the 1) and the 2):
$${r}_{i j} = \{ \begin{matrix}{F}_{i} intersects with {F}_{j} ⇔ {F}_{i} ⋂ {f}_{j} \neq ∅ \\ {F}_{i} above {F}_{j} ⇔ {z}_{i} ( x , y ) \geq {z}_{j} ( x , y ) or {F}_{i} below {F}_{j} ⇔ {z}_{i} ( x , y ) \leq {z}_{j} ( x , y )\end{matrix}$$
the rᵢ_{ⱼ} is set based on geological conditions, utilizing a geological intersection relationship between the Fᵢ and the Fⱼ and a chronological order of formation of the Fᵢ and the Fⱼ.

2. The method for constructing the unified geoinformation model according to claim 1, wherein, determining the global spherical grid partitioning system specifically comprises:
determining a grid origin;
constructing a multi-level spherical surface grid division scheme;
setting multi-level resolutions, which are compatible with the multi-level spherical surface grid division scheme; and
encoding spherical surface grids according to the multi-level spherical surface grid division scheme.

3. The method for constructing the unified geoinformation model according to claim 2, wherein, determining the subsurface spatial three-dimensional grid partitioning system comprises:
determining a three-dimensional grid starting point;
constructing a multi-level three-dimensional grid division scheme;
setting multi-level resolutions, which are compatible with the multi-level three-dimensional grid division scheme; and
encoding three-dimensional grids according to the multi-level three-dimensional grid division scheme.

4. The method for constructing the unified geoinformation model according to claim 1, wherein, modeling the three-dimensional grid model based on the global spherical surface grid partitioning system and the subsurface spatial three-dimensional grid partitioning system, and assigning values for the three-dimensional grid model, comprise:
obtaining multi-dimensional geological data; constructing a three-dimensional geological structure model based on the multi-dimensional geological data; and generating, under boundary constraints of the three-dimensional geological structure model, a three-dimensional geoscience attribute model for a subsurface three-dimensional space or an interior of a geological body;
integrating data of three-dimensional geological structure models and three-dimensional geoscience attribute models that originate from a plurality of sources; and uniformly converting the data into the data model of the unified geoinformation model;
integrating data of subsurface spatial artificial structure models that originate from a plurality of sources; and uniformly converting the data into the data model of the unified geoinformation model;
assigning, based on the data model of the unified geoinformation model, spatio-temporal semantic attributes to the three-dimensional grid model; performing management on grid attributes and grid attribute values.

5. The method for constructing the unified geoinformation model according to claim 4, wherein, when integrating the data of the three-dimensional geological structure models, the three-dimensional geoscience attribute models, or the subsurface spatial artificial structure models that originate from the plurality of sources, the data are classified and identified by performing operations of:
using a training dataset to pre-train a large model; inputting a model integration scenario classification dataset into the large model; adjusting parameters of the large model; outputting the large model having post-adjusted parameters;
calculating, based on the large model and a small model, a clustering loss for feature distribution output by each same data instance in the model integration scenario classification dataset;
the small model matching, by using a standard cross-entropy loss function, true labels of data instances to obtain a standard cross-entropy loss;
determining an overall loss function based on the clustering loss and the standard cross-entropy loss; updating parameters of the small model through backpropagation, until the overall loss function converging; and outputting the small model;
classifying and identifying the data using the small model.

6. The method for constructing the unified geoinformation model according to claim 5, wherein, calculating, based on the large model and the small model, the clustering loss for feature distribution output by each same data instance in the model integration scenario classification dataset, comprises:
for each same data instance in the model integration scenario classification dataset, after being processed by the large model and the small model respectively, outputting a first feature distribution and a second feature distribution respectively;
mapping the first feature distribution and the second feature distribution respectively to different reproducing kernel Hilbert spaces;
calculating clustering centers for all feature distributions, which are output by the large model and the small model when processing a plurality of data instances with a same label, to obtain a first clustering center and a second clustering center; and
calculating a clustering-center distance between the first clustering center and the second clustering center; calculating a sum of all clustering-center distances for all first clustering centers and all respective second clustering centers across all labels is calculated to obtain the clustering loss.

7. The method for constructing the unified geoinformation model according to claim 1, wherein, performing the numerical simulation on the three-dimensional grid model comprises geological process simulation, time attribute encoding, and extension encoding.
